(19) United States
(12) Patent Application Publication
(10) Pub. No.: US 2008/0112744 A1
(43) Pub. Date: May 15, 2008

(54) SHEET CONVEYING APPARATUS AND IMAGE FORMING APPARATUS

(75) Inventor: Hiroshi Saito, Kashiwa-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/937,733

(22) Filed: Nov. 9, 2007

(30) Foreign Application Priority Data
Nov. 15, 2006 (JP) 2006-308518

(51) Int. Cl. G03G 15/00

(52) U.S. Cl. 399/361; 399/395

(57) ABSTRACT

A sheet conveying apparatus according to the invention includes a first stator in which plural belt-like electrodes are arranged in a surface of an insulator at predetermined intervals in a sheet conveying direction; a second stator in which plural belt-like electrodes are arranged in a surface of an insulator at predetermined intervals in a direction orthogonal to the sheet conveying direction; a power supply which applies at least two types of voltages to the electrodes of each of the stators; and control unit which controls the at least two types of the voltages while switching the voltages applied to the electrodes of each of the stator from the power supply, wherein the first stator and the second stator are caused to face each other to form a sheet conveying path such that the electrodes of the stators are orthogonal to each other.

### BACKGROUND OF THE INVENTION

1. Field of the Invention

The present invention relates to a sheet conveying apparatus for utilizing an electrostatic force to convey a sheet and an image forming apparatus including the sheet conveying apparatus.

2. Description of the Related Art

Conventionally, in the image forming apparatus such as a copying machine and a printer, the sheet conveying apparatus conveys the sheet using a conveying roller which is rotated by a driving mechanism including a motor, an electromagnetic clutch, and a gear. In conveying the sheet in a direction orthogonal to the sheet conveying direction, for example, in conveying the sheet to correct position shift in a sheet width direction, the sheet is conveyed to cause an end portion in the sheet width direction of the sheet to abut on an abutting plate using an obliquely conveying roller which conveys the sheet in an oblique direction.

However, in the obliquely conveying roller which conveys the sheet in the oblique direction, a stress is applied to the sheet, and a wrinkle or a flaw is possibly generated when particularly the sheet having low stiffness such as thin paper is conveyed. When the sheet is conveyed using the obliquely conveying roller for conveying the sheet in the oblique direction, the complicated mechanism is required because it is necessary to open movement of the sheet by releasing pressures of roller pairs for nipping and conveying the sheet on the upstream and downstream sides of the obliquely conveying roller.

Therefore, there is proposed a method in which an electrostatic force is utilized to convey the sheet without nipping the sheet (for example, see Japanese Patent Application Laid-Open No. 2-285978). In the method, electrodes (stators) are disposed in two directions of an x-axis and a y-axis on the same plane, and voltages are applied to the electrodes to generate the electrostatic forces, whereby the sheet (moving member) is moved (conveyed) in the x-axis and y-axis directions by utilizing the electrostatic forces. As used herein, the two directions of the x-axis and y-axis shall mean the sheet conveying direction and the sheet width direction conveying direction orthogonal to the sheet conveying direction.

However, in the method, disclosed in Japanese Patent Application Laid-Open No. 2-285978, because the electrodes in the x-axis and y-axis directions are disposed in the same plane, unfortunately the sufficient electrostatic forces acting on the sheet are not obtained in the x-axis and y-axis directions. This is attributed the fact that the conveying force of each electrode cannot be generate with respect to the whole surface of the sheet because electrode areas in the x-axis and y-axis directions are disposed while divided in the same plane.

In view of the foregoing, an object of the invention is to provide a sheet conveying apparatus in which the sheet can be conveyed with the sufficient conveying force in the sheet conveying direction and the direction orthogonal to the sheet conveying direction.

### SUMMARY OF THE INVENTION

In accordance with the invention, a sheet conveying apparatus includes a first stator in which plural belt-like electrodes are arranged in a surface of an insulator at predetermined intervals in a sheet conveying direction; a second stator in which plural belt-like electrodes are arranged in a surface of an insulator at predetermined intervals in a direction orthogonal to the sheet conveying direction; a power supply which applies at least two types of voltages to the electrodes of each of the stators; and control unit which controls the at least two types of the voltages while switching the voltages applied to the electrodes of each of the stator from the power supply, wherein the first stator and the second stator are caused to face each other to form a sheet conveying path such that the electrodes of the stators are orthogonal to each other.

According to the invention, the whole surface of each of the stators which are disposed while electrodes of the stators are orthogonal to each other can be used to convey the sheet in one direction. Therefore, the sufficient conveying force can be generated for the whole surface of the sheet in the sheet conveying direction and the direction orthogonal to the sheet conveying direction, and the sheet can be stably conveyed irrespective of a type of the sheet.

Further features of the present invention will become apparent from the following description of exemplary embodiments (with reference to the attached drawings).

### BRIEF DESCRIPTION OF THE DRAWINGS

FIG. 1 is a sectional view showing an entire configuration of an image forming apparatus;

FIG. 2 is a plan view showing stator electrode arrangement;

FIG. 3 is a sectional view schematically showing a pattern of voltages applied to a stator;

FIG. 4 is a perspective view showing a sheet conveying path formed by the stator;

FIG. 5 is a view for explaining a pattern of voltages applied to two electrodes in a time sharing mode;

FIG. 6 is a control block diagram of a sheet conveying apparatus; and

FIG. 7 is a timing chart showing voltages applied to electrode groups of the stator electrode in time series.

### DESCRIPTION OF THE EMBODIMENTS

An exemplary embodiment of the invention will be described below with reference to the drawings. However, sizes, materials, and shapes of components described in the following embodiments and a relative arrangement among the components shall appropriately be changed depending on a configuration and various conditions of an apparatus to which the invention is applied. Accordingly, the invention is not limited to the sizes, materials, shapes, and relative arrangement of the embodiments unless otherwise noted.

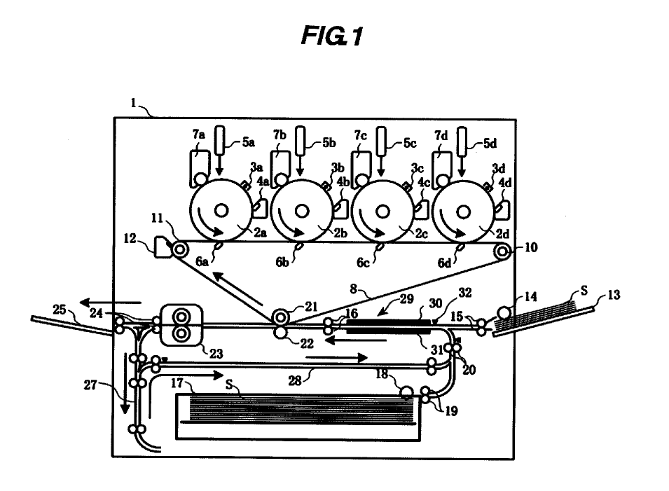

FIG. 1 is a sectional view showing an entire configuration of an image forming apparatus including a sheet conveying apparatus in which the electrostatic force is utilized, and FIG. 1 illustrates a schematic configuration of an electrophotographic-system full-color printer.

FIG. 1 shows a printer main body 1, four-color photosensitive drums 2a to 2d, chargers 3a to 3d, cleaners 4a to 4d, laser scanning units 5a to 5d, transfer blades 6a to 6d, and development units 7a to 7d. There are also shown in FIG. 1 an intermediate transfer belt 8, rollers 10 and 11 which support the intermediate transfer belt 8, and a cleaner 12.

FIG. 1 also shows a manual feed tray 13 in which sheets S are stored, pickup rollers 14 and 15, and a registration roller 16; a sheet cassette 17 in which the sheets S are stored, pickup rollers 18 and 19 for the sheet cassette 17, and a longitudinal path roller 20. There are also shown in FIG. 1 a rotating roller 21, a secondary transfer roller 22, a fixing device 23, a discharge roller 24, and a discharge tray 25.

In the printer having the configuration of FIG. 1, the laser scanning units 5a to 5d which have semiconductor lasers as a light source form color electrostatic latent images on the photosensitive drum 2a to 2d respectively, and the development devices 7a to 7d develop the electrostatic latent images respectively. Color toner images developed on the photosensitive drums 2a to 2d are respectively transferred onto the intermediate transfer belt 8 by the transfer blades 6a to 6d while superposed one another. The toner images which transferred onto the transfer belt 8 while superposed one another are collectively transferred to the sheet S by the secondary transfer roller 22. In the toner images collectively transferred to the sheet S, a fixing unit including the fixing device 23 and the discharge roller 24 melts the toner to form the permanent image.

On the other hand, the sheet S is selectively fed from the sheet cassette 17 or manual feed tray 13. A sheet conveying apparatus 29 utilizes an electrostatic force to convey the sheet S to the secondary transfer roller 22 while the sheet S is synchronized with the image using the registration roller 16. At this point, stepping motors separately drive the sheet conveying portions such as the pickup rollers 18 and 19 which feed the sheet S from the sheet cassette 17, the longitudinal path roller 20, the registration roller 16, and the pickup rollers 14 and 15 which feed the sheet S from the manual feed tray 13, which allows a conveying operation to be stably realized at high speed.

During duplex printing, the sheet passing through the fixing device 23 and discharge roller 24 is guided in a direction of a duplex reversing path 27, and the sheet S is reversely conveyed to a duplex path 28. The sheet S which passes already through the duplex path 28 passes through the longitudinal path roller 20 again. Then, similarly to the first surface, the image is formed, transferred, and fixed on a second surface, and the sheet is discharged.

The sheet conveying apparatus 29 which utilizes the electrostatic force to convey the sheet will be described below. As shown in FIG. 1, in the sheet conveying apparatus 29, a sheet conveying path is provided while a first stator 30 and a second stator 31 faces each other in parallel. In each of the first stator 30 and second stator 31, plural electrodes are arranged in parallel at predetermined intervals in one direction.

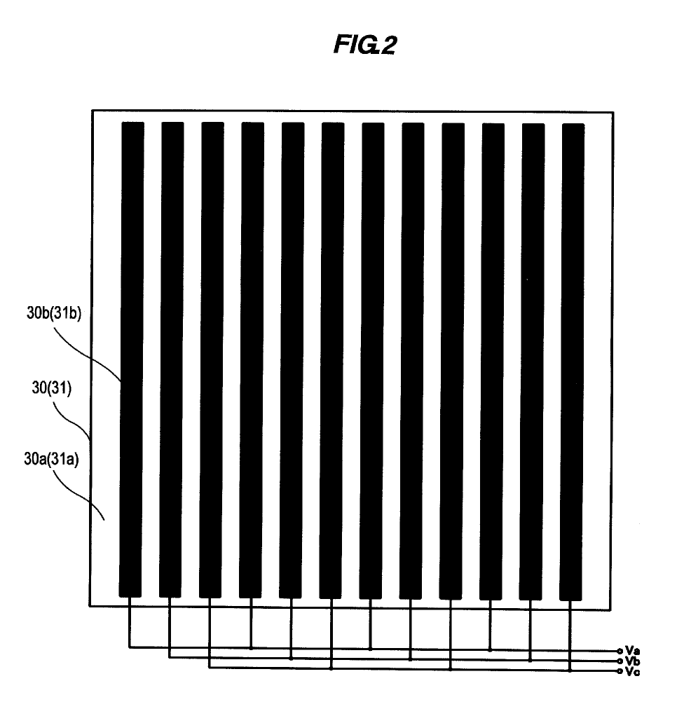

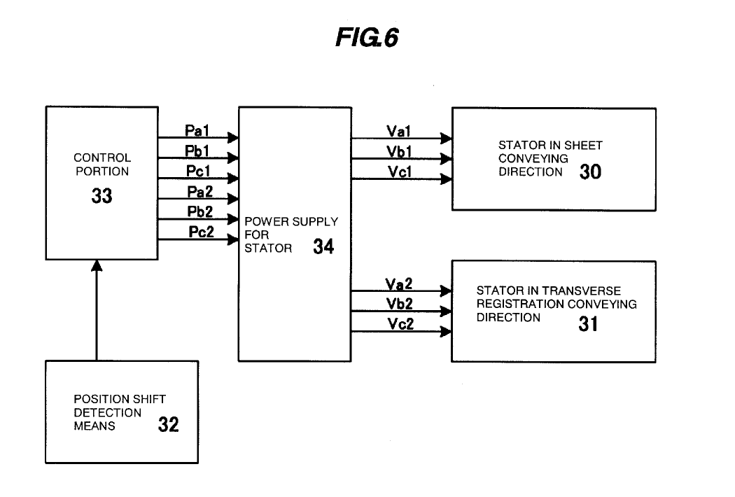

FIG. 2 is a plan view explaining the stator included in the sheet conveying apparatus 29. Referring to FIG. 2, a stator 30 includes an insulator 30a and plural belt-like electrodes 30b. The insulator 30a is provided in one of surfaces of the sheet conveying path, and the electrodes 30b are arranged in a comb shape at predetermined intervals in the surface of the insulator 30a. The electrodes 30b are configured such that at least two types of voltages are applied from a power supply. In this case, the electrodes 30b are divided into three groups and the electrodes of the groups are alternately arranged. Three types of voltages Va, Vb, and Vc are applied to the electrodes 30b of the groups from a power supply 34 (FIG. 6) for the stator. The voltages Va, Vb, and Vc are applied while switched at predetermined conditions by a control unit 33 (FIG. 6). The stator 31 facing the stator 30 is configured in the same way.

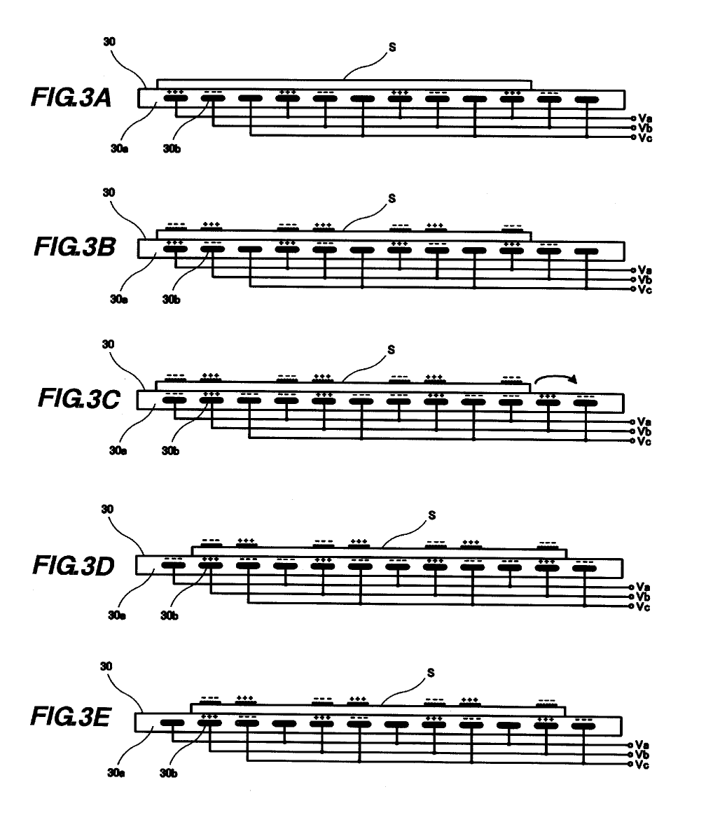

FIG. 3 is a sectional view schematically showing the stator 30 of FIG. 2, and FIG. 3 shows a sequence of the sheet conveyance. In the state in which the sheet S is in contact with the stator 30, the different voltages Va, Vb, and Vc are applied to the groups of the electrodes 30b.

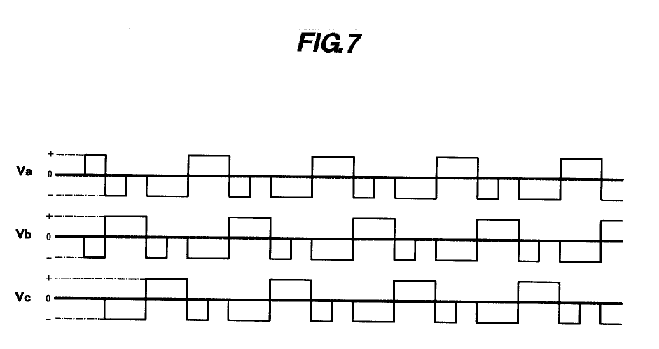

When Va=1000V, Vb=−1000V, and Vc=0V are applied to the groups of the electrodes 30b as shown in FIG. 3A, a charge pattern is transferred to the sheet S as shown in FIG. 3B. When Va=−1000V, Vb=1000V, and Vc=−1000V are applied to the groups of the electrodes 30b as shown in FIG. 3C, the sheet S is moved as shown in FIG. 3D. As shown in FIG. 3E, Va=0V, Vb=1000V, and Vc=−1000V are applied to the groups of the electrodes 30b to recharge the charges lost during the movement. Then, the processes from FIG. 3C to FIG. 3E are repeated to convey the sheet S. A voltage applying pattern of FIG. 7 is obtained when the time series of the sequence is expressed in each of the voltages Va, Vb, and Vc applied to the electrode groups.

Thus, the control unit 33 (FIG. 6) performs control such that the three types of voltages Va, Vb, and Vc are applied to the electrodes of the stator while switched, which allows the sheet to be conveyed in the direction in which the electrodes of the stator are arranged in parallel.

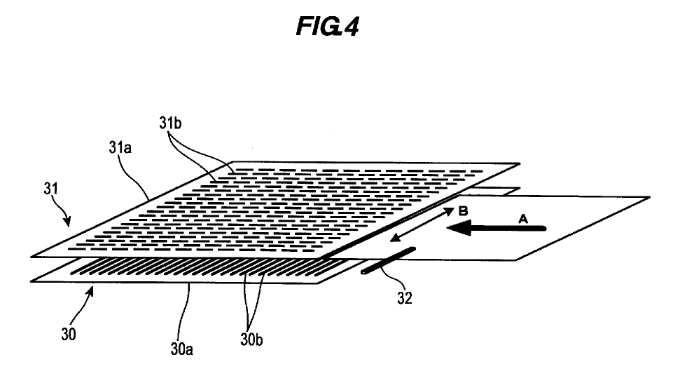

In the sheet conveying apparatus 29, the first stator 30 and the second stator 31 are configured in the same way as shown in FIG. 2, the first stator 30 and the second stator are disposed while facing each other such that the electrodes of the stators are orthogonal to each other (intersect at 90 degrees) as shown in FIG. 4, thereby forming the sheet conveying path. In the first stator 30, the electrodes are arranged in parallel at predetermined intervals in the sheet conveying direction. In the second stator 31, the electrodes are arranged in parallel at predetermined intervals in the direction orthogonal to the sheet conveying direction. That is, the electrodes 30b of the first stator 30 are arranged in the direction orthogonal to the sheet conveying direction, and the electrodes 31b of the second stator 31 are arranged in parallel with the sheet conveying direction. When the sheet S passes through the conveying path formed by the stators 30 and 31 facing each other, the voltages are applied while switched as described above. Therefore, the first stator 30 generates the conveying force in the direction shown by an arrow A of FIG. 4 with respect to the sheet S, and the second stator 31 generates the conveying force in the direction shown by an arrow B of FIG. 4.

The sheet conveying apparatus 29 also includes position shift detection unit 32 for detecting a shift amount of the sheet in the sheet width direction (transverse registration direction) orthogonal to the sheet conveying direction. As shown in FIGS. 1 and 4, the position shift detection unit 32 is disposed on the upstream side of the sheet conveying path (the stators 30 and 31).

FIG. 6 is a control block diagram of the sheet conveying apparatus. The control unit 33 outputs control signals Pa1, Pb1, Pc1, Pa2, Pb2, and Pc2 to the power supply 34 for the stator according to a detection signal from the position shift detection unit 32. The power supply 34 for the stator applies voltages Va1, Vb1, and Vc1, voltages Va2, Vb2, and Vc2 to the electrodes of the stators 30 and 31 according to the control signals.

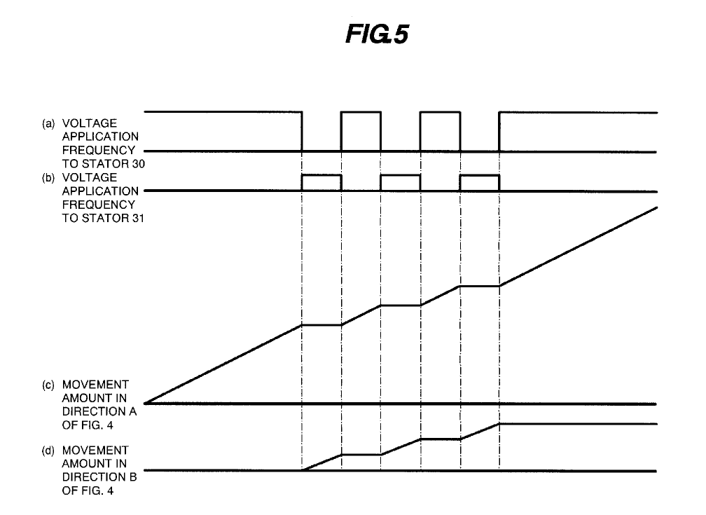

As shown in FIG. 5, in the voltage application to each stator, a voltage application frequency (a) to the stator 31 which conveys the sheet in the sheet conveying direction (direction shown by the arrow A of FIG. 4) and a voltage application frequency (b) to the stator 30 which conveys the sheet in the sheet width direction (direction shown by the arrow B of FIG. 4) are switched in a time-shared mode. That is, the voltage application to the electrodes of the first stator 30 and the voltage application to the electrodes of the second stator 31 are performed in the time-shared mode. Therefore, the electric charges are charged on the sheet surface in a consistent manner, so that the strong conveying forces can stably generated in the sheet conveying direction and the sheet width direction.

In the stators 30 and 31 which are disposed while the electrodes are orthogonal to each other, the whole surface of one of the stators 30 and 31 can be used for the conveying force in one direction. Therefore, the sufficient conveying forces can stably generated for the whole surface of the sheet in the sheet conveying direction and the direction orthogonal to the sheet conveying direction, and the sheet can be stably conveyed irrespective of the type of the sheet.

Additionally, the position shift detection unit 32 detects the shift amount in the sheet width direction, and the number of steps of the voltage applied to the second stator 31 is changed according to the detected shift amount. The sheet S can be moved to a predetermined position according to the number of steps of the applied voltage by a stepping motor. Therefore, the sheet and the image can accurately be aligned with each other to print the image at the desired position in the sheet.

The sheet conveying apparatus including the stators, in which the sheet is conveyed in the sheet width direction and the direction orthogonal to the sheet width direction by the stators formed by the belt-like electrodes provided in parallel in one direction, is used as the conveying portion of the image forming apparatus to perform the transverse registration correction before the transfer in the embodiment. However, the invention is not limited to the embodiment. For example, the sheet conveying apparatus including the stators may be used in another sheet conveying portion of the image forming apparatus or a sheet conveying portion of a sheet processing apparatus which processes the sheet received from the image forming apparatus.

In the embodiment, the stators 30 and 31 are formed in the same structure such that the stators 30 and 31 differ from each other only in the orientation of the electrode group. However, the invention is not limited to the embodiment. The numbers of electrodes of the stators 30 and 31 and lengths of the electrodes may appropriately be set according to the application of the sheet conveying portion.

Although the printer is illustrated as the image forming apparatus in the embodiment, the invention is not limited to the embodiment. For example, a scanner, a copying machine, and a facsimile or a multi function peripheral in which functions of the scanner, the copying machine, and the facsimile are combined may be used as the image forming apparatus. The same effects can be obtained by applying the invention to the sheet conveying apparatus used in the pieces of image forming apparatus.

Although the sheet conveying apparatus which is integral with the image forming apparatus is illustrated as the image forming apparatus in the embodiment, the invention is not limited to the embodiment. For example, a sheet conveying apparatus which is detachably attached to the image forming apparatus may be used, and the same effects can be obtained by applying the invention to the sheet conveying apparatus.

Although the sheet conveying apparatus which conveys the sheet such as the recording paper of the recording target is illustrated in the embodiment, the invention is not limited to the embodiment. For example, the same effect can be obtained even if the invention is applied to a sheet conveying apparatus which conveys a sheet such as a document of a reading target.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2006-308518, filed Nov. 15, 2006, which is hereby incorporated by reference herein in its entirety.

What is claimed is:

1. A sheet conveying apparatus comprising:
a first stator in which a plurality of belt-like electrodes are arranged in a surface of an insulator at predetermined intervals in a sheet conveying direction;
a second stator in which a plurality of belt-like electrodes are arranged in a surface of an insulator at predetermined intervals in a direction orthogonal to the sheet conveying direction;
a power supply which applies at least two types of voltages to the electrodes of each of the stators; and
a control unit which controls the at least two types of the voltages while switching the voltages applied to the electrodes of each of the stator from the power supply,
wherein the first stator and the second stator are caused to face each other to form a sheet conveying path such that the electrodes of the stators are orthogonal to each other.

2. The sheet conveying apparatus according to claim 1, wherein voltage application to the electrodes of the first stator and voltage application to the electrodes of the second stator are performed in a time-shared mode.

3. The sheet conveying apparatus according to claim 1, comprising position shift detection unit which detects a position shift amount of a sheet in the direction orthogonal to the sheet conveying direction, wherein the two types of voltages are applied to the electrodes of the second stator while switched according to detection result of the position shift detection unit, and thereby conveying the sheet in the direction orthogonal to the sheet conveying direction.

4. An image forming apparatus which forms an image in a sheet, the image forming apparatus comprising a sheet conveying apparatus which conveys a sheet,
wherein the sheet conveying apparatus includes:
a first stator in which a plurality of belt-like electrodes are arranged in a surface of an insulator at predetermined intervals in a sheet conveying direction;
a second stator in which a plurality of belt-like electrodes are arranged in a surface of an insulator at predetermined intervals in a direction orthogonal to the sheet conveying direction;
a power supply which applies at least two types of voltages to the electrodes of each of the stators; and
control unit which controls the at least two types of the voltages while switching the voltages applied to the electrodes of each of the stator from the power supply, and
the first stator and the second stator are caused to face each other to form a sheet conveying path such that the electrodes of the stators are orthogonal to each other.

5. The image forming apparatus according to claim 4, wherein voltage application to the electrodes of the first stator and voltage application to the electrodes of the second stator are performed in a time-shared mode.

6. The image forming apparatus according to claim 4, comprising position shift detection unit which detects a position shift amount of a sheet in the direction orthogonal to the sheet conveying direction, wherein the two types of voltages are applied to the electrodes of the second stator while switched according to detection result of the position shift detection unit, and thereby conveying the sheet in the direction orthogonal to the sheet conveying direction.
